(19) United States
(12) Patent Application Publication
(10) Pub. No.: US 2003/0067671 A1
(43) Pub. Date: Apr. 10, 2003

(54) High reliability optical amplification

(76) Inventors: Mohammed N. Islam, Allen, TX (US); Carl A. deWilde, Richardson, TX (US); Michael J. Freeman, Canton, MI (US)

Correspondence Address: Baker Botts L.L.P., 2001 Ross Avenue, Suite 600, Dallas, TX, 75201-2980, US

(21) Appl. No.: 09/971,436

(22) Filed: Oct. 5, 2001

(51) Int. Cl. H01S 3/00

(52) U.S. Cl. 359/337

(57) ABSTRACT

In one aspect of the invention, a method of amplifying optical signals includes identifying one of a plurality of pump signals driving an amplification system as a failing pump signal comprising a reduced power compared to a normal power of the failing pump signal. The method further includes adjusting the power of at least one other of the plurality of pump signals based at least in part on the failing pump signal to at least partially compensate for a degradation of performance of the amplification system that would otherwise be caused by the reduction in power of the failing pump signal.

### TECHNICAL FIELD OF THE INVENTION

The present invention relates generally to communication systems, and more particularly to a system and method for providing highly reliable amplification of optical signals.

### BACKGROUND OF THE INVENTION

Many conventional optical amplification systems rely solely on erbium doped amplifiers to increase the communication range of the system. When an erbium-doped amplifier is not amplifying, it acts to absorb the optical signal. Consequently, when a pump driving an erbium doped amplifier fails, the performance of the entire amplification system can suffer dramatically. To address this problem, erbium doped amplification systems typically require one hundred percent redundancy in their driving pumps. That is, for each driving pump in an erbium doped system, a normally inactive redundant pump is available to provide the same pump power ordinarily derived from the primary pump. As driving pumps are typically among the most expensive components in an optical amplifier, a one hundred percent redundancy requirement for driving pumps generally results in significant extra amplifier cost.

### SUMMARY OF THE INVENTION

The present invention recognizes a need for a highly reliable optical amplification system and method that reduces or eliminates the need for one hundred percent redundancy in driving pumps.

In one aspect of the invention, a method of amplifying optical signals comprises identifying one of a plurality of pump signals driving an amplification system as a failing pump signal comprising a reduced power compared to a normal power of the failing pump signal. The method further comprises adjusting the power of at least one other of the plurality of pump signals based at least in part on the failing pump signal to at least partially compensate for a degradation of performance of the amplification system that would otherwise be caused by the reduction in power of the failing pump signal.

In another aspect of the invention, a method of amplifying optical signals comprises identifying any one of a plurality of active pump signals driving an amplification system as a failing pump signal comprising a reduced power compared to a normal power of the failing pump signal, where each of the plurality of active pump signals is generated by an active pump source. The method further comprises at least partially compensating for a degradation that would otherwise be caused by the reduction in power of the failing pump signal without requiring a redundant pump source for each of the active pump sources.

In another aspect of the invention, a method of amplifying optical signals comprises identifying a failing amplifier pump signal comprising a reduced power compared to a normal power of the failing amplifier pump signal. The method further comprises, in response to identifying the failing amplifier pump signal, adjusting the power of another amplifier pump signal within the same amplifier stage of the same amplifier as the failing pump signal and adjusting the power of another pump signal within another amplifier stage of the same amplifier as the failing pump signal.

In still another aspect of the invention, a method of amplifying optical signals comprises identifying a failing amplifier pump signal comprising a reduced power compared to a normal power of the failing amplifier pump signal. The method further comprises, in response to identifying the failing amplifier pump signal, adjusting the power of another amplifier pump signal within the same amplifier stage of the same amplifier as the failing pump signal and adjusting the power of another pump signal within another amplifier serving the same optical link as the amplifier comprising the failing pump signal.

In another aspect of the invention, an optical amplification system comprises a pump assembly operable to generate a plurality of pump signals driving at least a portion of an amplification system, and a monitor operable to identify a failing pump signal comprising one of the plurality of pump signals having a reduced power compared to a normal power of the failing pump signal. The system further comprises a controller operable to adjust the power of at least one other of the plurality of pump signals based at least in part on the failing pump signal to at least partially compensate for a degradation of performance of the amplification system that would otherwise be caused by the reduction in power of the failing pump signal.

In another aspect of the invention, an optical amplification system comprises an active pump assembly operable to generate a plurality of active pump signals driving at least a portion of an amplification system and a monitor operable to identify a failing pump signal comprising one of the plurality of active pump signals having a reduced power compared to a normal power of the failing pump signal. The system further comprises a controller operable to compensate for a degradation of performance of the amplification system that would otherwise be caused by the reduction in power of the failing pump signal without requiring a redundant pump source for each active pump source within the active pump assembly.

In still another aspect of the invention, an optical communication system comprises one or more optical transmitters operable to generate alone or collectively a plurality of signal wavelengths and a wavelength division multiplexer (WDM) operable to combine the plurality of signal wavelengths into a single multiple wavelength signal for transmission over a transmission medium. The system further comprises a pump assembly operable to generate a plurality of pump signals driving at least a portion of an amplification system coupled to the transmission medium and a monitor operable to identify a failing pump signal comprising one of the plurality of pump signals having a reduced power compared to a normal power of the failing pump signal. In addition, the system comprises a controller operable to adjust the power of at least one other of the plurality of pump signals based at least in part on the failing pump signal to at least partially compensate for a degradation of performance of the amplification system that would otherwise be caused by the reduction in power of the failing pump signal.

Depending on the specific features implemented, particular embodiments of the present invention may exhibit some, none, or all of the following technical advantages. One embodiment of the present invention provides a novel system and method for compensating for performance degradation that might otherwise result from a failing pump signal in an optical amplifier.

Pumps can be adjusted in the same amplifier stage, in other amplifier stages of the same amplifier, and/or in other amplifiers serving the same optical link as the amplifier experiencing the failing pump signal. At least with respect to shorter wavelength pump signals, nearly perfect, or at least significant compensation can be achieved by adjusting pump powers associated with remaining pump signals in the same amplification stage as the failing pump signal. This is particularly advantageous in light of the fact that pump signal failures are often more likely to occur in the higher power, shorter wavelength, pump signals, where intra-stage compensation is most effective.

Adjusting pumps within the same amplifier stage can also provide significant compensation when longer wavelength pumps fail. Furthermore, compensation can also be provided in these and other failure situations by adjusting pumps in other amplification stages of the same amplifier. This technique allows the amplifier to leverage the fact that longer wavelength pumps generally operate below total output capacity or discard a portion of the pump power during normal operation. Rerouting a portion of this pump power to a failing amplifier stage facilitates compensation as well as conservation of pump resources.

Moreover, significant compensation can be realized by adjusting pumps in other amplifiers serving the same optical link as the amplifier experiencing the pump failure. This compensation technique can be utilized alone, or in combination with intra-stage compensation and/or inter-stage compensation.

Through use of one or a combination of these and/or other compensation techniques, various embodiments of the present invention facilitate highly reliable optical amplification without requiring 100% redundancy of driving pump signals. This facilitates effective and efficient communication of optical signals over various distances while minimizing the costs associated with optical amplifiers in the system.

Other technical advantages of the present invention will be readily apparent to one skilled in the art from the following figures, description and claims.

### BRIEF DESCRIPTION OF THE DRAWINGS

For a more complete understanding of the present invention, and for further features and advantages thereof, reference is now made to the following description taken in conjunction with the accompanying drawings, in which:

FIG. 1 is a block diagram showing an exemplary optical communication system constructed according to the teachings of the present invention;

FIG. 2 is a block diagram showing one example of an optical amplifier constructed according to the teachings of the present invention;

FIGS. 3a-3l are graphs illustrating simulated results obtained when utilizing intra-stage compensation in response to detecting a failing pump signal;

FIG. 4 is a block diagram showing another example of an optical amplifier constructed according to the teachings of the present invention;

FIG. 5 is a graph illustrating simulated results obtained when utilizing a combination of intra-stage compensation and inter-stage compensation in response to detecting a failing pump signal;

FIG. 6 is a block diagram showing yet another example embodiment of an amplification system constructed according to the teachings of the present invention;

FIGS. 7a-7b are graphs illustrating a combination of intra-stage compensation and inter-amplifier compensation for a failing pump signal according to the teachings of the present invention;

FIGS. 8a-8c are block diagrams illustrating example embodiments of polarization randomizers constructed according to the teachings of the present invention; and

FIG. 9 is a flow chart showing one example of a method of communicating optical signals constructed according to the teachings of the present invention.

### DETAILED DESCRIPTION OF THE DRAWINGS

FIG. 1 is a block diagram showing an exemplary optical communication system 10 operable to facilitate communication of one or more optical signals without requiring one hundred percent redundancy in amplifier driving pumps. In one particular embodiment, system 10 facilitates at least partial compensation for a degradation of performance that would otherwise be caused by one or more failing pump signals by implementing intra-stage compensation, inter-stage compensation, and/or inter-amplifier compensation for the failing pump signal(s).

In this example, system 10 includes a transmitter bank 12 operable to generate a plurality of wavelength signals (or channels) 16a-16n. Each wavelength signal 16a-16n comprises a wavelength or range of wavelengths of light substantially different from wavelengths carried by other signals 16. In one embodiment, each one of a plurality of transmitters 12a-12n is operable to generate an optical signal having at least one wavelength that is distinct from wavelengths generated by other transmitters 12a-12n. Alternatively, a single transmitter 12 operable to generate a plurality of wavelength signals could be implemented.

In the illustrated embodiment, system 10 also includes a combiner 14 operable to receive multiple signal wavelengths 16a-16n and to combine those signal wavelengths into a single multiple wavelength signal 16. As one particular example, combiner 14 could comprise a wavelength division multiplexer (WDM). The terms wavelength division multiplexer and wavelength division demultiplexer as used herein may include equipment operable to process wavelength division multiplexed signals and/or dense wavelength division multiplexed signals.

System 10 communicates optical signal 16 over an optical communication medium 20. Communication medium 20 can comprise a plurality of spans 20a-20n of fiber, each separated by an optical amplifier. As used in this document, the term “span” refers to an optical medium coupled to one or more amplifiers. As particular examples, fiber spans 20a-20n could comprise standard single mode fiber (SMF), dispersion-shifted fiber (DSF), non-zero dispersion-shifted fiber (NZDSF), or other fiber type or combinations of fiber types.

Two or more spans of communication medium 20 can collectively form an optical link. As used herein, the term “optical link” refers to a plurality of optical spans coupled to one or more amplifiers. Optical receivers, cross-connects, add/drop multiplexers, and/or other devices operable to terminate, cross-connect, switch, route, or otherwise process optical signals could also comprise part of an optical link. In the illustrated example, communication medium 20 includes a single optical link comprising numerous spans 20a-20n. System 10 could include any number of additional links.

In this example, system 10 includes a booster amplifier 18 operable to receive and amplify wavelengths of signal 16a in preparation for transmission over a communication medium 20. Where communication system 10 includes a plurality of fiber spans 20a-20n, system 10 can also include one or more in-line amplifiers 22a-22n. In-line amplifiers 22 reside between fiber spans 20a-20n and operate to amplify signal 16 as it traverses communication medium 20. Optical communication system 10 can also include a preamplifier 24 operable to receive signal 16 from a final fiber span 20n and to amplify signal 16 prior to passing that signal to a separator 26.

Separator 26 may comprise, for example, a wavelength division demultiplexer (WDM). Separator 26 operates to separate individual wavelength signals 16a-16n from multiple wavelength signal 16. Separator 26 can communicate individual signal wavelengths or ranges of wavelengths 16a-16n to a bank of receivers 28 and/or other optical communication paths.

Amplifiers 18, 22, and 24 could each comprise, for example, a discrete Raman amplifier, a distributed Raman amplifier, or a combination of these amplifier types. In addition, one or more stages of system 10 could include semiconductor amplifiers or rare-earth doped amplifiers, such as erbium or thulium doped amplifiers.

In some embodiments, multiple wavelength signal 16 carries wavelengths from different communications bands (e.g., the short band (S-band), the conventional band (C-band), and/or the long band (L-band)). In those cases, amplifiers 18, 22, and 24 could comprise all band amplifiers, each operable to amplify all signal wavelengths received. Alternatively, one or more of those amplifiers could comprise a combination of amplifier assemblies coupled in parallel, each operable amplify a portion of the wavelengths of multiple wavelength signal 16. In that case, system 10 could incorporate wavelength division multiplexers and demultiplexers surrounding the groups of parallel amplifier assemblies to facilitate separation of the wavelength groups prior to amplification and recombination of the wavelengths following amplification.

System 10 may also comprise a management system 30 operable to track and/or manage one or more aspects of the performance of that amplifier or of the optical link containing that amplifier. Although the illustrated embodiment shows management system 30 directly coupled to each amplifier, management system could alternatively communicate with some or all of the amplifiers via communication medium 20 using, for example, an optical service channel. In addition, although management system 30 is depicted as a single entity located remotely from amplifiers 18-24, all or a part of management system 30 could alternatively reside locally to one or more amplifiers in system 10.

At least some of the amplifiers in system 10 include driving pumps operable to provide pump signals to optical medium 20 to facilitate Raman amplification through interaction between the pump signals and the signal being communicated over medium 20. At least one of the Raman amplifiers in system 10 includes or has access to control/monitoring functionality, operable to detect a failing pump signal. As used throughout this document, the term “failing pump signal” refers to a pump signal that experiences a particular reduction in power. The reduction may comprise a complete failure resulting in an approximately zero pump power for the failing pump signal. As another example, the reduction may comprise a loss of power that is greater than some predetermined threshold level. A failing pump signal may result, for example, from a completely failed pump or from a pump that has weakened due to, for example, its age.

System 10 operates to identify failing pump signals and to adjust the power of other pump signals in system 10 to at least partially compensate for what would otherwise be a degradation of performance of the amplifier due to the failing pump signal. The degradation in performance for which compensation is desired could be, for example, a distortion of the gain curve for an amplifier or the system, or an increase in the noise figure for the amplifier or the system.

In response to the failing pump signal, system 10 can adjust the power of other pump signals in the same amplifier stage as the failing pump signal, in another amplifier stage of the same amplifier as the failing pump signal, and/or in another amplifier in the same optical link as the failing pump signal. As a result, system 10 can at least partially, and often times fully, compensate for a degradation in amplifier performance that would otherwise occur as a result of the failing pump signal.

System 10 provides a significant advantage over conventional amplification systems in providing a mechanism for ensuring amplifier reliability without requiring one hundred percent redundancy for all driving pumps. As one particular example of such a mechanism, utilizing other active driving pumps in the system to compensate for failing pump signals significantly reduces the cost of the amplification system, while maintaining good system reliability.

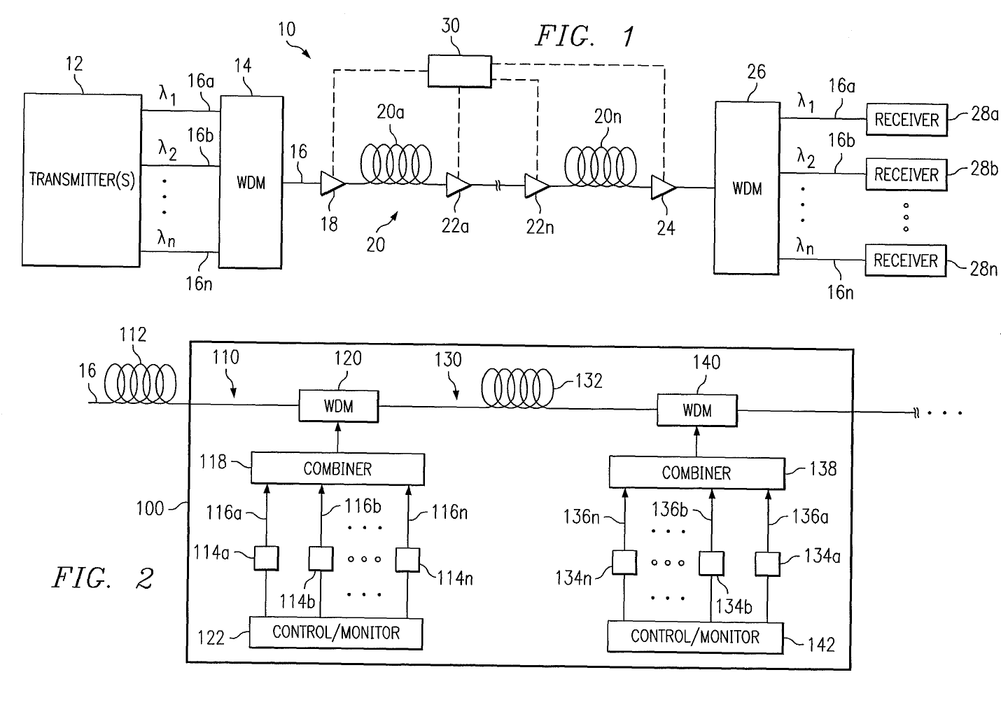

FIG. 2 is a block diagram showing one example of an optical amplifier 100 operable to provide intra-stage compensation for failing pump signals by altering the power of other already active driving pumps in the same amplification stage. In this particular example, amplifier 100 comprises a multiple stage Raman amplifier using a distributed Raman amplifier in a first stage 110 and a discrete Raman amplifier in a second stage 130. Amplifier 100 could comprise any number of stages (including a single stage). Furthermore, all amplifier stages of amplifier 100 could comprise one type of amplifier, such as an all discrete Raman amplifier, or an all distributed Raman amplifier. In other embodiments, non-Raman amplification stages and/or amplifiers could be used in addition to the Raman amplification stages.

In this example, first amplifier stage 110 includes a gain medium 112 comprising approximately eighty kilometers of SMF-28 fiber. Second stage 130 includes a gain medium 132 comprising approximately thirteen kilometers of DK-30 fiber. Other fiber types and lengths of fiber could be used.

First stage 110 further includes a plurality of pumps 114a-114n each operable to produce one of pump signals 116a-116n. Pumps 114a-114n can be viewed as a pump assembly. Throughout this document, the term “pump assembly” can refer to a collection of pumps serving a common amplification stage, a collection of pumps serving multiple amplification stages of an amplifier, or a collection of pumps serving different amplifiers of a common optical link.

As one particular example, each pump 114 could comprise a laser diode, although other pump mechanisms could be used. In addition, although this example shows a separate pump 114 producing each pump signal 116, a single pump 114 could be implemented to produce various wavelength pump signals 116.

Each pump signal comprises a distinct wavelength. In a particular example, first stage 110 includes six pumps 114 each operable to generate a pump signal at a particular wavelength. For example, during normal operation, pump signals 116 may provide the following power at the following wavelengths:

| pump wavelength: | pump power: |
|---|---|
| 1396 nm | 560 mW |
| 1416 nm | 560 mW |
| 1427 nm | 560 mW |
| 1455 mm | 250 mW |
| 1472 nm | 100 mW |
| 1505 nm | 85 mW |

Second stage 130 also includes a plurality of pumps 134a-134n. In at least some embodiments, pumps 114 and 134 can be viewed as a pump assembly. In this particular example, second stage 130 includes five pumps 134, each operable to generate a pump signal 136 at a particular wavelength. As a particular example, during normal operation, pump signals 136 may provide the following power at the following wavelengths:

| pump wavelength: | pump power: |
|---|---|
| 1405 nm | 470 mW |
| 1418 nm | 530 mW |
| 1445 nm | 310 mW |
| 1476 nm | 85 mW |
| 1509.5 nm | 25 mW |

Each of first stage 110 and second stage 130 can include a pump signal combiner 118 and 138, respectively. Pump signal combiners 118 and 138 operate to combine multiple pump wavelengths for communication to combiners 120 and 140, respectively. Combiners 120 and 140 each operate to facilitate interaction between pump signals 116 and multiple wavelength signal 16 and between pump signals 136 and multiple wavelength signal 16, respectively. Combiners 118 and 120 although shown as separate entities, could be combined into a single signal combiner. Likewise, combiners 138 and 140 could reside as a single combining device.

Although the illustrated embodiment shows the use of counter propagating pump signals compared to the propagation of wavelength signal 16, co-propagating pump signals or a combination of co-propagating and counter-propagating pump signals could also be used without departing from the scope of the invention.

In this example, each stage 110 and 130 includes controller/monitor functionality 122, 142, respectively. Controller/monitor functionality 122, 142 may comprise any hardware, software, firmware, or combination thereof operable to identify a failing pump signal and to adjust the power of one or more other pump signals in response to identifying the failing pump signal. Although this example depicts a separate controller/monitor functionality for each amplifier stage, a single controller/monitor functionality could be implemented for providing these functions to two or more amplification stages, or to more than one amplifier in the optical link. Moreover, although controller/monitor 122 and 142 functionality are shown as single blocks, the control and monitoring functions of these entities could be logically and/or physically separate and could be operated over numerous processors.

In operation, amplifier 100 receives multiple wavelength signal 16 at first amplification stage 110 and propagates that signal toward combiner 120. Combiner 120 facilitates communicating pump signals 116 and multiple wavelength signal 16 over gain medium 112. In this particular example, Raman gain results from the interaction of intense light from the pump signals 114 with the signals 16 and optical phonons in gain medium 112. The Raman effect leads to a transfer of energy from one optical beam (the pumps) to another optical beam (the signals).

Various circumstances can lead to one or more driving pumps degrading or failing completely. For example, the power of pump signal 116a produced by driving pump 114a could partially deteriorate due to the age of pump 114. As another example, pump signal 116a could completely fail resulting in an approximately zero power pump signal.

Controller/monitor functionality 122 identifies failing pump signal 116. For example, controller/monitor 122 may periodically, on a random basis, or continuously monitor the output of pumps 114 and compare those outputs to predetermined threshold levels. The output power of pumps 114 could be monitored, for example, by observing outputs or back facets of laser diodes generating the pump signals, or at built-in monitor photodiodes of the lasers. The predetermined threshold levels could be selected, for example, to facilitate identifying only completely failed pumps, or to identify pumps operating at a particular level below their normal operational power.

Upon identifying the failing pump signal, controller/monitor 122 determines an appropriate correction measure based at least in part on the failing pump signal. In one example, controller/monitor 122 may use the identification of the failing pump signal to index a look-up table that identifies adjustments to remaining pump signal powers to compensate for the failing pump signal. As another example, controller/monitor 122 may apply a value associated with the failing pump signal 116a to an algorithm to determine appropriate adjustments to one or more of the remaining pump signals. Feedback loops provide still another example of a mechanism useful in adjusting the power of one or more pump signals in response to detecting the failing pump signal. In embodiments where a portion of a pump signal from one amplifier stage is used to compensate for a failing pump signal in another amplifier stage, rerouting a non-failing pump signal from one stage to another stage experiencing a failing pump signal could comprise the adjustment to the pump signal.

The adjustment to the other pump signal(s) is typically (but need not always be) an increase in the power of the other pump signal(s). Increasing the power of one or more remaining pump signals can be done in a variety of ways. For example, in many cases, pumps 114 deliver pump signals 116 at powers below the rated capacity of the pump. Increasing the powers of the resulting pump signals in that case can comprise increasing the pump output to more closely match the rated capacity of the pump. In other cases, increasing the power of the resulting pump signal can comprise driving the pump beyond its rated capacity, at least for a short time until the failing pump can be repaired or replaced.

In this particular example, controller/monitor 122 determines adjustments to be made to other pump signals 116b-116n in the same amplifier stage 110 as the failing pump signals. By adjusting other pump signals 116 in the same amplifier stage, amplifier 100 can at least partially compensate for degradations in the performance of the amplifier that would otherwise result from failing pump signal 116a.

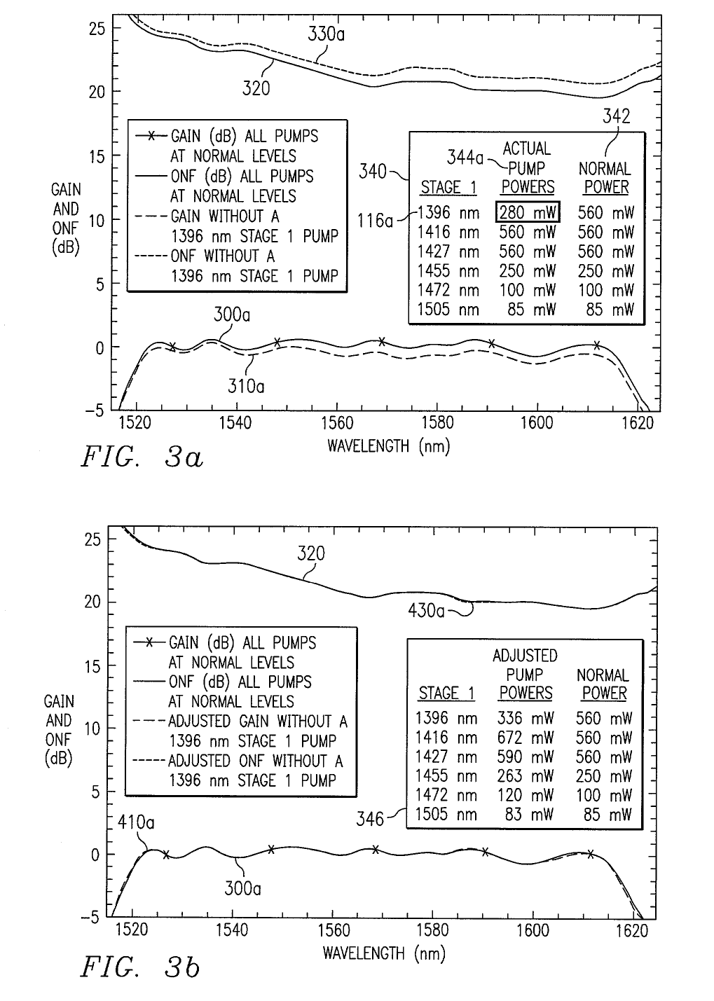

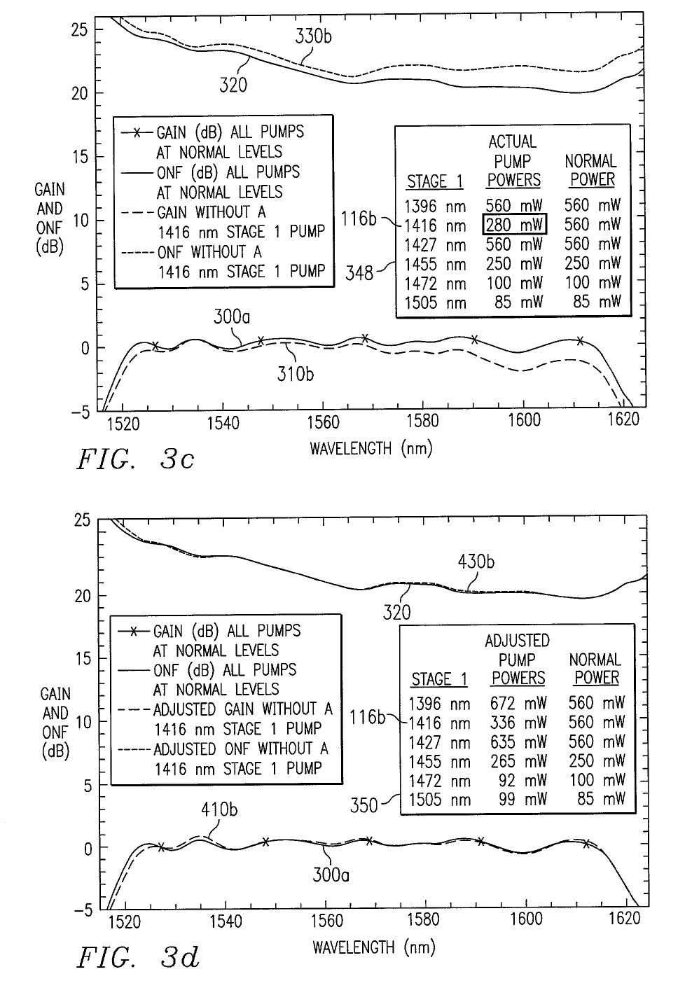

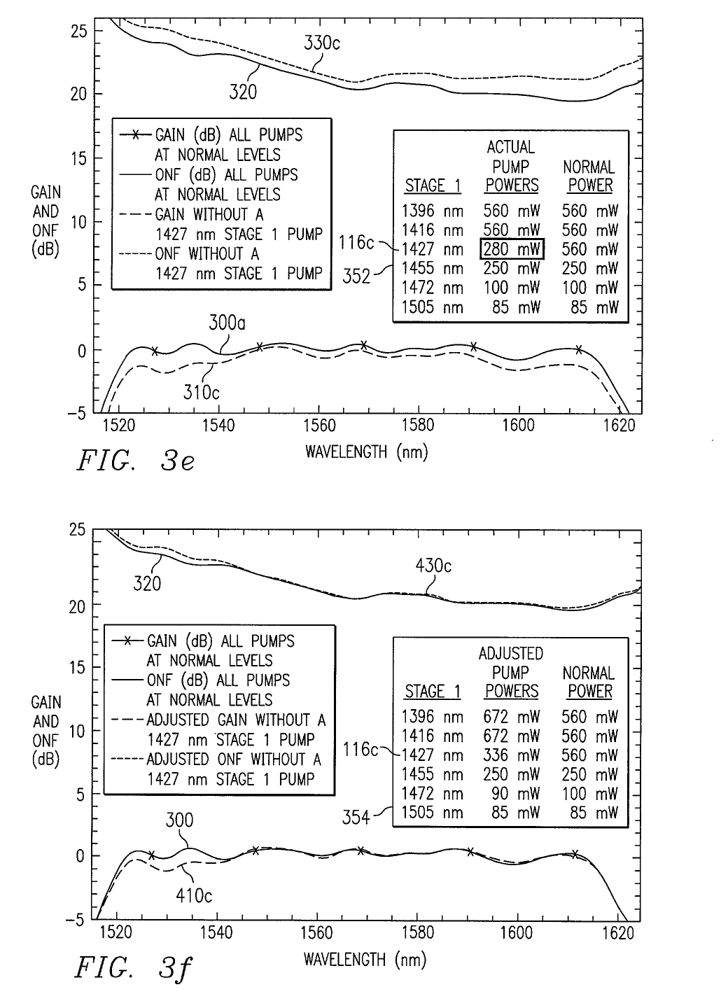

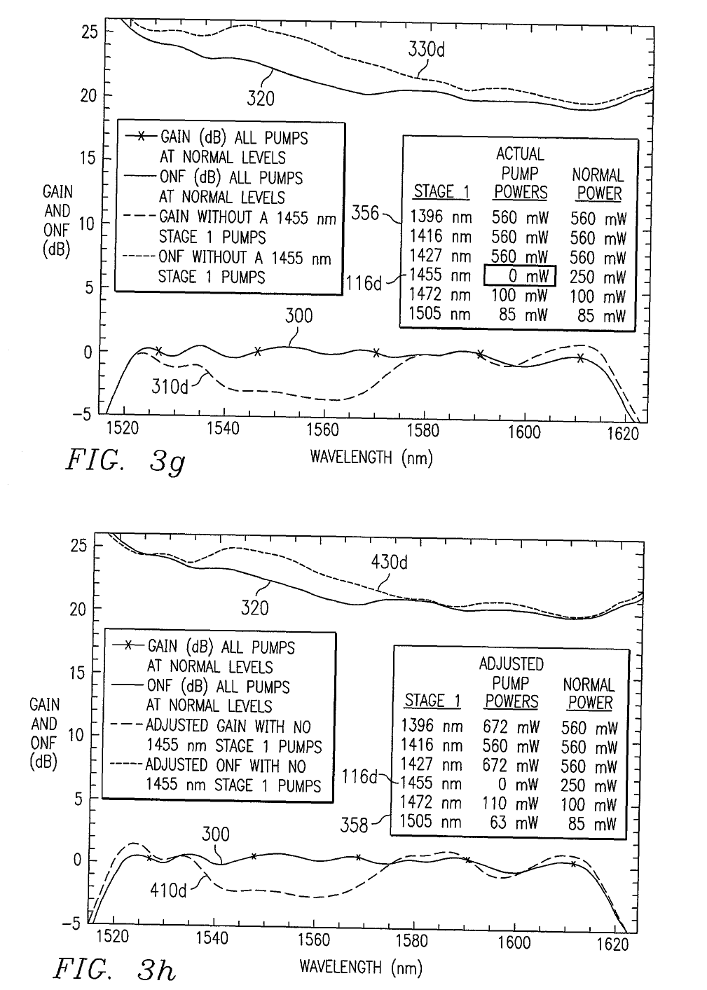

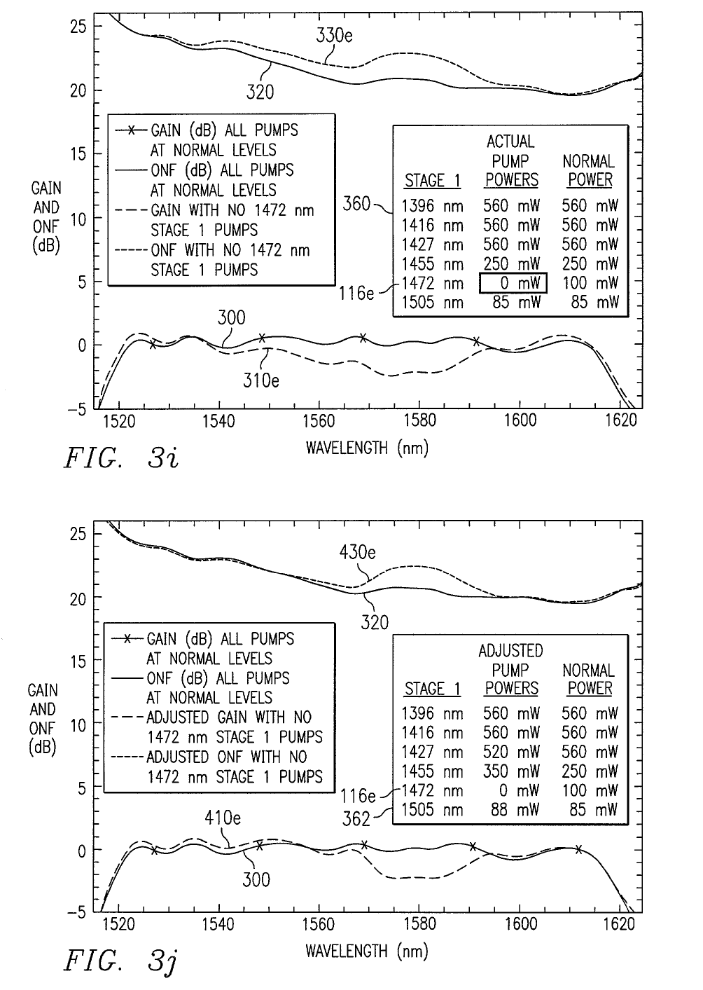

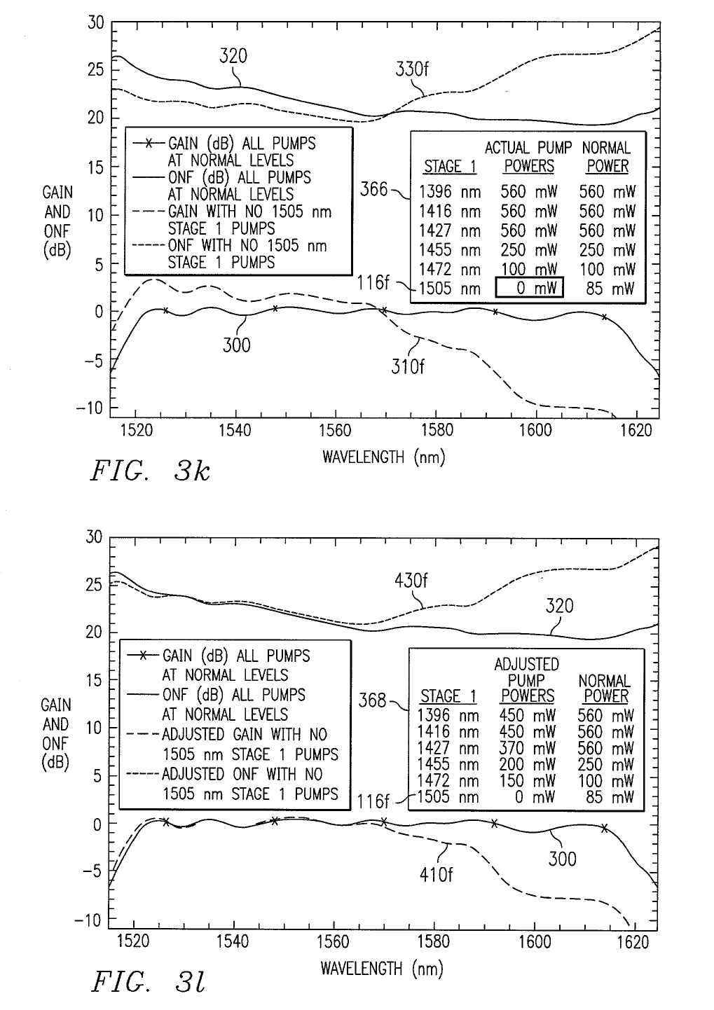

FIGS. 3a-3l are graphs illustrating intra-stage compensation when various ones of six driving pump signals 116 experience a failure. Each of these scenarios assumes that one of the six pump signals is a failing signal and assumes that compensation is provided by adjusting other pump signals in the same amplifier stage. Although these examples show a single failing pump signal, this technique equally applies to multiple failing pump signals.

FIG. 3a is a graph comparing the operation of amplifier 100, depicted in FIG. 2, during normal operation and also after the failure of the shortest wavelength pump emitting a pump signal 114a operating 1396 nanometers. Line 300 shows the gain of amplifier 100 when all pumps 114 and 134 are operating at normal power levels. Line 320 shows the optical noise figure (ONF) for amplifier 100 while all pumps 114 and 134 operate at normal power levels.

This particular example assumes a failing pump signal 116a occurring at a wavelength of 1396 nanometers. In this example, the pumps 114a supplying pump signal 116a to first amplification stage 110 generate a pair polarization multiplexed pump signals, each having a power of 280 milliwatts (mW). This example assumes that one of the polarization multiplexed pump signals 114a is eliminated due to some failure condition. As a result, pump signal 116a at a wavelength of 1396 nanometers experiences a power reduction from 560 milliwatts to 280 milliwatts. FIG. 3a includes a chart 340 illustrating the normal pump powers 342 versus the actual pump powers 344 at each pump upon failure of pump signal 114a.

Line 310a shows the resulting gain curve for amplifier 100 upon the failure in pump 114a. Line 330a shows the resulting optical noise figure associated with amplifier 100 following the failure of pump 114a. As shown in FIG. 3a, the failure of pump 114a causes a reduction in amplifier gain across the amplified spectrum, and an increase in the optical noise figure across the amplified spectrum.

FIG. 3b is a graph illustrating compensated operation of amplifier 100 in response to the failure of pump signal 116a. As in FIG. 3a, line 300 in FIG. 3b shows the gain curve associated with amplifier 100 during normal operation. Similarly, as in FIG. 3a, line 320 shows the optical noise figure associated with amplifier 100 during normal operation. Chart 346 shown in FIG. 3b shows the adjustments made to the powers of pump signals 116 in first amplifier stage 110 to at least partially compensate for the degradation in performance illustrated by lines 310a and 330a in FIG. 3a.

In this embodiment, all but one of the remaining pumps 114 are adjusted to result in an increase in power of the resulting pump signals 116, while the power of the pump supplying the longest wavelength pump signal (in this case 1505 nanometers) is decreased. Decreasing the power of the longest wavelength pump signal is due to the Raman interaction between pump signals 116, which causes longer wavelength pump signals to receive energy from shorter wavelength pump signals. Due to that effect, and in light of the increase in power to the shorter wavelength pump signals 116a-116n-1, the longest wavelength pump signal 116n can be slightly reduced in this example.

As shown in FIG. 3b, intra-stage amplification—adjusting the powers of pump signals in the same amplification stage 110 as failing pump signal 114a—provides significant compensation to the amplifier performance. Line 410a shows the compensated gain curve for amplifier 110. Compensated gain curve 410a very closely matches normal operational gain curve 300 associated with the same amplifier. Likewise, line 430a shows the compensated optical noise figure associated with amplifier 110. Compensated optical noise FIG. 430a very closely matches noise FIG. 320 associated with normal amplifier operation.

The particular numerical examples provided herein are intended for illustrative purposes only. Depending on the particular design of the amplifier including the number of channels being amplified, the number and spectral location of pump signals being utilized, and the characteristics of the physical components implemented, numerous combinations of amplifier adjustments could result in at least partially compensating degrading effects caused by failing pump signals. This example illustrates that changing the powers of other pump signals in the same amplifier stage as a failing pump signal can provide significant compensating effects both to the gain of the amplifier and the optical noise figure associated with the amplifier.

FIGS. 3c and 3d are similar to FIGS. 3a and 3b, except that FIGS. 3c and 3d show the uncompensated and compensated operation of amplifier 100 when a pump signal 116b at a wavelength 1416 nanometers experiences a failure. In this example, pump signal 116b operating under normal power comprises a polarization multiplexed signal having a power of 560 milliwatts. This example assumes that one of the components of the polarization multiplexed pump signal fails completely, resulting in a reduction of pump signal power by 280 milliwatts at 1416 nanometers. In FIG. 3c, line 310b shows the degradation of the gain curve of amplifier 110 resulting from the failure of pump signal 116b, while line 330b shows the degradation of the optical noise figure associated with amplifier 100 due to that failure. Chart 348 shows the reduction in power of pump signal 116b due to the failure.

FIG. 3d is a graph showing the results of compensating for failing pump signal 116b by adjusting the pump powers of the remaining pump signals in the same amplification stage as the failing pump signal. Chart 350 shows the adjusted pump powers resulting in compensated gain curve 410b and compensated optical noise FIG. 430b.

FIGS. 3b and 3d show that for failures in at least the shorter wavelength pump signals, nearly perfect, or at least significant compensation can be achieved by adjusting pump powers associated with remaining pump signals in the same amplification stage as the failing pump signal. This is particularly advantageous in light of the fact that pump signal failures are generally more likely to occur in the higher power, shorter wavelength, pump signals, where intra-stage compensation is most effective.

FIGS. 3e and 3f show gain profiles and optical noise figures for uncompensated and compensated versions of amplifier 100, respectively, where pump signal 116c operating at 1427 nanometers is the failing pump signal. Once again, in this example, pump signal 116c comprises a polarization multiplexed signal resulting from the combination of orthogonally polarized pump signal components from two separate pump sources. This example assumes that one of the two pump sources has failed.

In FIG. 3e, line 310c shows the reduced gain performance of amplifier 100 due to failing signal 116c. Line 330c shows the degradation of the optical noise figure associated with the amplifier due to failing signal 116c. Table 352 in FIG. 3e shows the resulting power of failing signal 116c due to the failure of one of the components of that signal.

FIG. 3f shows gain curve 410c and optical noise FIG. 430c resulting from adjusting pump powers of at least some of the remaining pump signals 116 in response to failing pump signal 116c. Table 354 shows adjusted pump powers at each pump wavelength used to provide the compensation shown. FIG. 3f shows that although modifying the pump powers of the remaining pump signals in the same amplification stage as a mid-wavelength failing pump signal 116c does not perfectly compensate, it localizes the drop in the gain curve and the increase in the noise figure to a narrow bandwidth. This significantly increases the performance of amplifier 100 compared to its performance without compensation. Moreover, as will be discussed in further detail below, additional compensation can be provided by modifying pump signals in other amplification stages of amplifier 100, and/or in other amplifiers in the same optical length.

FIGS. 3g and 3h show a comparison between gain curves and optical noise figures for uncompensated and compensated versions, respectively, of amplifier 100. This example assumes that pump signal 116d operating at 1455 nanometers completely fails, resulting in a zero power (approximately 0 milliwatts) pump signal at 1455 nanometers. Line 310d shows the loss of performance in the gain of amplifier 100, while curve 330d shows the degradation of the optical noise figure of amplifier 100 due to failing pump signal 116d.

FIG. 3h shows an example of compensation levels that can be achieved by modifying the powers of one or more remaining pump signals 116 in the same amplification stage as failing pump signal 116d. Lines 410d and 430d show the ability to localize the effects of a longer wavelength failing pump signal 116d by adjusting the power of remaining pump signals in the same amplification stage. Chart 358 shows example adjustments that can be made to remaining pump signals 116 to provide the illustrated compensation.

FIGS. 3i and 3j show a similar compensation scenario used when a pump signal 116e operating at 1472 nanometers completely fails. Line 310e shows the sag in the gain curve resulting from failing pump signal 116e, while line 330e shows the degradation of the optical noise figure resulting from that condition. Table 360 provides a numerical comparison of pump powers before and after the reduction in power to failing pump signal 116e.

FIG. 3j shows corresponding gain and optical noise figure curves in a compensated system. In this example, other pump signals 116 in the same amplification stage 110 as failing pump signal 116e are modified to compensate for failing signal 116e. Lines 410e and 430 show how the effects of failing signal 116e can be localized to a narrow bandwidth. Again, as will be discussed further below, additional compensation can be provided to ameliorate even the localized degradation shown in FIG. 3j.

FIGS. 3k and 3l show uncompensated and compensated results, respectively, for amplifier 100 where the longest wavelength pump signal 116f operating at 1505 nanometers completely fails. As shown in FIG. 3k, failure of the longest wavelength pump signal 116f dramatically effects the gain of amplifier 100 as well as the optical noise figure of the amplifier.

FIG. 3l shows that some amount of compensation can be provided in response to a failing longest wavelength pump signal by adjusting the powers of the remaining pump signals 116 in the same amplification stage. Line 410f shows the gain curve resulting from that compensation, while line 430f shows the optical noise figure resulting from that compensation.

As can be appreciated by comparing FIGS. 3a-3l, the longer the wavelength of the failing pump signal, and the closer that wavelength is to the band of amplified signals 16, the more significant the deterioration of the gain and the optical noise figure of the amplifier. Even in the worst case scenario, where the longest wavelength pump signal 116f completely fails, adjusting remaining pump signals in the same amplification stage still provides an appreciable level of compensation to the system.

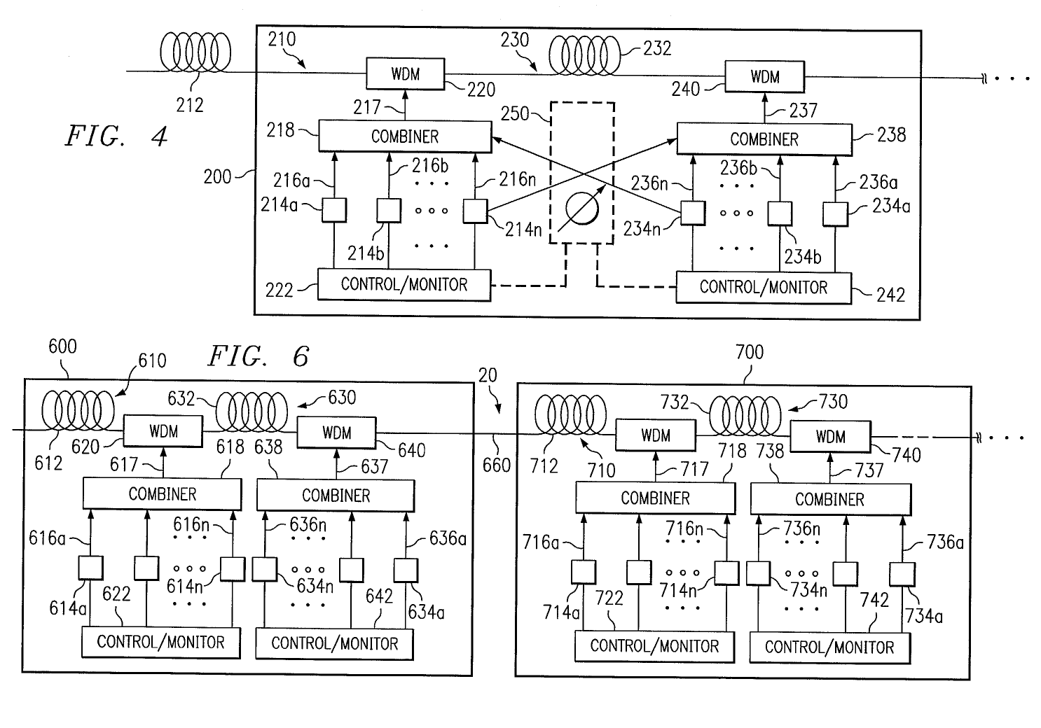

FIG. 4 is a block diagram showing one example of another embodiment of an amplifier 200 operable to provide inter-stage compensation (e.g., between two stages in the same amplifier) for failing pump signals. In this example, amplifier 200 is identical to amplifier 100 described with respect to FIG. 2, except that a portion of one or more pump signals from first stage 210 are routed to second stage 230, and a portion of one or more pump signals from second stage 230 are routed to first stage 210. In particular, in this example, a portion of the longest wavelength pump signal 216n is routed from pump 214 into combiner 238 of second stage 230. Likewise, a portion of longest wavelength pump signal 236n from second stage 230 is routed from pump 234n to combiner 218 of first stage 210. Pumps 214 and pumps 234 can, at least in some embodiments, be viewed as a pump assembly.

This embodiment illustrates how pump signals in one amplification stage can be used to compensate for the degrading effects of a failing pump signal in another stage of the same amplifier. Although this particular embodiment shows a direct connection between pumps in one amplification stage and combiners in another amplification stage, pump power could be routed between stages in any of a number of ways.

For example, any of the embodiments described herein may include one or more lossy elements coupled between stages. Isolators operable to reduce propagation of Rayleigh scattered light, wavelength division multiplexers/demultiplexers operable to provide mid-stage access, add/drop multiplexers, and gain equalizers provide just a few examples of such lossy elements. As one particular example, a wavelength division multiplexer/demultiplexer could reside between amplification stages and could direct pump signals from one amplification stage for combination with signals in the failing pump stage.

In some cases, the wavelength division multiplexer could direct particular wavelength pump signals for combination with failing pump signals. In other cases, a wavelength division multiplexers/demultiplexer residing between amplification stages can comprise a dump port, which typically would lead to a heat sink used to dissipate unused laser power. The dump port redirects unused pump power away from other elements coupled to the gain fiber, such as isolators, to avoid damaging those elements. This is particularly true for longer wavelength pump signals, which, due to Raman interaction between pump signals, typically have the largest levels of unused pump power.

Rather than wasting this excess pump power, one aspect of the invention couples at least one driving pump in one stage of the amplifier with pump signals in another stage in the amplifier so that the otherwise wasted pump power in one amplifier stage can be utilized to compensate for a pump signal failure in another amplifier stage. Although this example shows two adjacent amplifier stages coupling pump power across stages, the concept could also be implemented in amplifier stages of the same amplifier that are not adjacent to one another. In addition, although this example shows coupling only the longest wavelength pump signals to other amplifier stages, the concept is equally applicable to additional pump wavelengths.

Typically, the closer the wavelength of the compensating pump to the wavelength of the failing pump, the better the compensation. Pump signal sources, such as laser diodes, typically emit light having some bandwidth of wavelengths approximately surrounding a center wavelength. Significant power may reside in the bandwidth surrounding the center wavelength, and may exist in multiple modes. The bandwidth surrounding the center wavelength may comprise, for example, approximately 1 nanometer. In the interest of clarity, relative spectral positions of the failing pump signal and the compensating pump signal can be discussed in terms of the spectral location of a center wavelength of each of those signals. In those terms, favorable results are generally obtained when a center wavelength of the compensating pump signal is within thirty nanometers of a center wavelength of the failing pump signal.

In one embodiment, pump wavelengths from one amplifier stage can be directly coupled to another amplifier stage to constantly supply pump power between stages. In that embodiment, during normal operation each amplifier stage receives a portion of its pump power from a pump in the same amplifier stage, and receives another portion of that power from a similar wavelength pump in another amplifier stage. In that case, in the event of a failure, it is very unlikely that the pump wavelength supplied by two separate stages will experience simultaneous complete failures. Thus, there will almost always be some level of pump power supplied at or near that wavelength.

Amplifier 200 shown in FIG. 4 further depicts another way of implementing inter-stage compensation. Amplifier 200 shows the optional use of control circuitry 250 interfacing with pump signals from one stage that serve another stage. Control circuitry 250 could comprise, for example, a variable attenuator, an optical amplifier, or any other functionality operable to selectively vary the power of an optical signal received. In this example embodiment, under normal operating conditions each amplifier stage could be supplied with pump signals provided by its own pumps. In the event of a failure, control/monitors 222 and/or 242 could manipulate control circuitry 250 to direct a portion of one or more pump signals from a separate amplifier stage to the amplifier stage experiencing the pump failure. The inter-stage compensation described herein could be used as a sole compensating mechanism, or could be used in combination with the intra-stage compensation described with respect to FIG. 2.

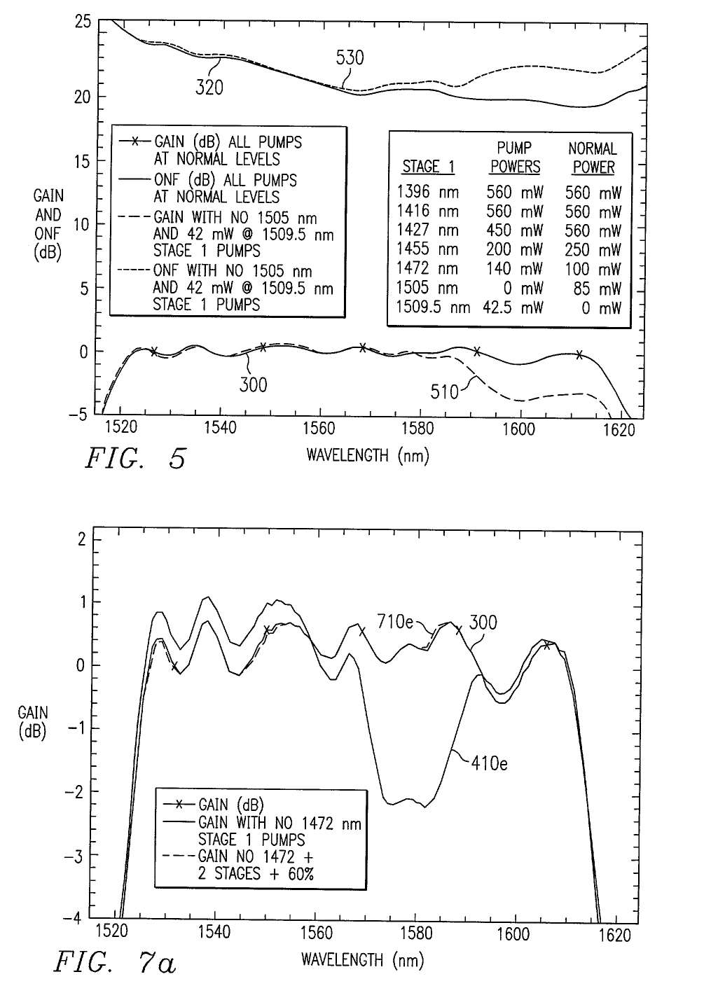

FIG. 5 is a graph illustrating results obtained when utilizing a combination of intra-stage compensation and inter-stage compensation in reaction to a failing pump signal occurring at the longest wavelength pump signal (in this case 1505 nanometers). Recall that FIG. 3k illustrates the uncompensated reaction of amplifier 100 when the longest wavelength pump signal 116f completely fails. FIG. 31 illustrates compensation achieved using only intra-stage compensation.

FIG. 5 shows the results of applying intra-stage amplification and inter-stage amplification within the same amplifier. In particular, line 510 illustrates the localization of the sag in the gain curve and line 530 illustrates the localization of the degradation of the optical noise figure associated with amplifier 200 when using this combination compensation technique. In this example, the longest wavelength pump signal 116f at 1550 nanometers completely fails. Other pump signals 116a-116e are modified to partially compensate using intra-stage compensation. In addition, a pump signal from second amplifier stage 230 is used to provide inter-stage compensation. The pump signal from second stage 230 in this example resides at 1509.5 nanometers.

Comparing FIG. 3l to FIG. 5 shows that the combination compensation scheme reduces the bandwidth of the affected region of the gain curve, and reduces the worst case optical noise figure for the amplifier, even where the longest wavelength pump signal completely fails in one stage.

FIG. 6 is a block diagram showing another embodiment of an amplification system operable to provide reliable optical amplification without requiring 100% redundancy in driving pumps. In particular, the embodiment shown in FIG. 6 facilitates inter-amplifier compensation, that is, pump signals in one amplifier are modified to compensate for degradation associated with a pump failing in another amplifier in the same optical link. Again, for brevity of description, each amplifier depicted in FIG. 6 is similar in structure and function to amplifier 100 shown in FIG. 1. Other amplifier designs could be implemented without departing from the scope of the invention.

In this particular example, each amplifier 600, 700 in FIG. 6 is capable of providing intra-stage compensation by adjusting other pumps in the same amplification stage as the failing pump signal. In addition, or in the alternative, each amplifier 600, 700 could be designed to provide inter-stage compensation by routing a portion of a pump signal in one amplification stage to another amplification stage experiencing a failing pump signal.

The embodiment depicted in FIG. 6 provides yet another mechanism for compensating for a failing pump signal. In particular, the amplification system shown in FIG. 6 provides for inter-amplifier compensation where pump signals in one amplifier can be used to compensate for a failing pump signal in another amplifier in the same optical link. As a particular example, pump signals in different amplifiers within the same optical link as the failing pump signal could be modified to provide compensation.

Favorable results are obtained where the center wavelength of the compensating pump signal is chosen at or near the center wavelength of the failing pump signal wavelength. To that end, it may be desirable to compensate using a pump signal in the same amplification stage of the compensating amplifier as that of the failing pump signal in the failing amplifier. In other words, if the failing pump signal occurs in the second amplifier stage of the failing amplifier, the compensating signal could be selected from pump signals serving the second stage of the compensating amplifier. This generally facilitates selecting a compensating pump signal having a wavelength that is the same as or near to the wavelength of the failing pump signal. Other pump signals or amplification stages could be selected, however, without departing from the scope of the invention.

In this technique, control/monitor functionality 622, 642, 722, 742 can be used to detect the failing pump signal. That functionality can then communicate instructions to another amplifier in the same optical link via a control signal 660 to modify pump signals in that amplifier in response to detecting the failing signal. Control signals 660 instructing the compensating amplifier can be communicated, for example, in an optical service channel along with other information carried by the optical link.

Again, although each amplification stage in amplifier 600 and 700 is shown as having a separate control/monitor functionality, some or all of the individual control/monitor functionality could be combined into fewer functional blocks, or even a single central functional block serving the entire optical link. Furthermore, the monitoring and control functionality could exist as logically and/or physically separate entities from one another.

As a particular example of operation, the pump producing pump signal 616c at a wavelength of 1427 nanometers 614c in first stage 610 of first amplifier 600 may experience a partial or complete failure. Control/monitor functionality 622 identifies failing pump signal 616c and generates control signal 660, which it communicates over optical link 20 to control/monitor functionality 722 of first amplifier stage of amplifier 700 in optical link 20. Control signal 660 instructs control/monitor 722 to modify the power of one or more pump signals 716 to at least partially compensate for the failure of pump signal 616c in first stage 610 of amplifier 600. In a particular example, control/monitor 722 of first stage 710 of amplifier 700 increases the power of pump signal 716c operating at the same wavelength as failing pump signal 616c. Control signal 660 could likewise be sent to other amplifiers (not explicitly shown) in optical link 20 instructing those amplifiers to likewise modify the power of pump signals associated with those amplifiers to compensate for failing pump signal 616c.

This inter-amplifier compensation technique could be used in conjunction with an intra-stage compensation technique and/or an inter-stage compensation technique. These techniques can be used to compensate for failing pump signals occurring in any amplifier stage of any amplifier in the optical link. Moreover, these techniques can be used to simultaneously compensate for multiple failing pump signals.

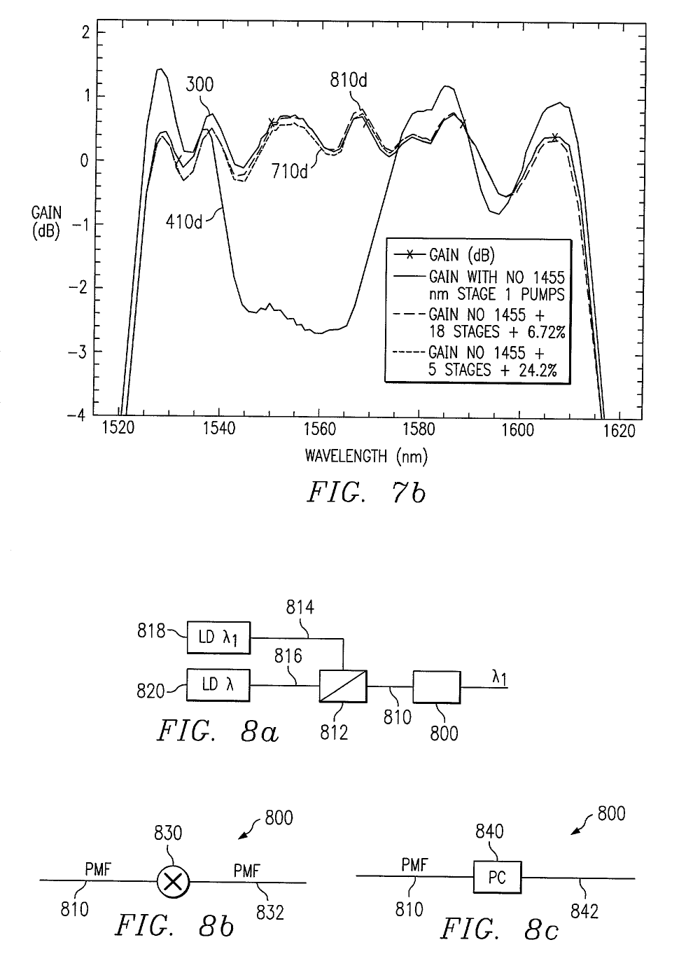

FIG. 7a is a graph illustrating a combination of intra-stage compensation and inter-amplifier compensation for a failing pump signal at 1472 nanometers in one stage of a three-stage amplifier. Referring back to FIGS. 3i and 3j, FIG. 3i shows uncompensated operation of a two-stage amplifier where a pump signal 116e at 1472 nanometers fails. FIG. 3j shows how the degrading effects of the failing pump signal 116e can be localized to a narrow bandwidth using intra-stage compensation, that is, compensating by adjusting the powers of other pump signals in the same amplification stage as the failing pump signal. Although this graph shows the results for a two-stage amplifier, the results would be largely the same for a three-stage amplifier where only intra-stage compensation was used. Notice that the majority of the adverse effects of the failing pump signal can be localized to a bandwidth between approximately 1565 nanometers and 1595 nanometers.

FIG. 7a uses an increased scale to highlight the details of the gain curve in this region. Line 300 shows the gain curve for the amplification system operating at normal pump powers. Line 410e shows the gain curve after intra-stage compensation has localized the dip in the gain curve to a region between approximately 1565 and approximately 1595 nanometers. Line 710e shows the results of using inter-amplifier compensation in addition to intra-stage amplification. As shown in FIG. 7a, the gain curve 710e for the amplification system after intra-stage compensation and inter-amplifier compensation nearly identically matches the gain curve during normal operation.

FIG. 7b is a graph showing simulated results for amplifier compensation when a pump signal at 1455 nanometers fails. This example shows a combination of intra-stage compensation and inter-stage compensation using a variety of amplifier stages. In FIG. 7b, line 300 represents the gain curve during normal operation of the amplifying system. Line 410d illustrates the gain curve for the amplification system after pump wavelength at 1455 nanometers in one of the stages fails and other pump wavelengths in the same amplification stage are modified to partially compensate for the failing pump signal. In this example, intra-stage compensation localizes the dip in the gain curve to a narrow bandwidth between approximately 1535 nanometers and 1570 nanometers.

Line 710d shows the gain curve for the amplification system after augmenting the intra-stage compensation with inter-amplifier compensation. In particular, line 710d represents the gain curve for a six-stage amplifier where the pump signals at 1455 nanometers in the first stages of the other five amplifiers in the system are increased by 24.2%. Similarly, line 810d shows the gain curve for a nineteen stage amplification system after augmenting the first stage intra-stage compensation with inter-amplifier compensation. In this case, the inter-stage amplifier compensation involves identifying the failing pump signal in the first stage of one of the amplifiers at 1455 nanometers, and increasing the power of each pump signal at 1455 nanometers in the first stage of the other 18 amplifiers by 6.72%. Although these examples assume that a pump failure occurs in a first stage of a first amplifier in the link, the compensation technique applies to any pump or pumps failing in any stage of any amplifier in the link.

As shown in FIG. 7b, using inter-amplifier compensation to complement intra-stage compensation can result in nearly perfect compensation for the amplifier despite the complete failure of one of the pump signals. This compensation results without the need for one hundred percent redundancy in driving pumps. In fact, this compensation can be achieved in various embodiments using no redundant pumps at all.

FIG. 8 is a block diagram of one example of a polarization randomizer 800 operable to randomize the polarization of an at least substantially uniformly polarized optical signal. Where pump signals comprise polarization multiplexed combination of uniformly polarized pump signals, there is a risk that polarization dependent gain will arise when one of the polarization multiplexed component pump signals fails. Polarization randomizer 800 addresses this problem by randomizing the polarization of the remaining polarization component of the failing pump signal.

The example of a polarization randomizer 800 shown in FIG. 8 includes a polarization maintaining fiber (PMF) 810, which receives a polarization multiplexed pump signal from a polarization beam combiner 812. A polarization beam combiner 812 receives pump component signals 814 and 816 from optical links coupled to laser sources 818 and 820, respectively. Each pump component signal 814 and 816 comprises a substantially uniform polarization that is approximately orthogonal to the other pump component. Polarization beam combiner 812 combines pump components 814 and 816 into a polarization multiplexed pump signal having a mixed polarization.

In the event of a failure of one of pump components 814 or 816, polarization randomizer 800 operates to scramble the polarization of the remaining pump component to reduce or eliminate polarization dependent gain that would otherwise occur. Polarization randomizer 800 can operate continuously, or can be activated upon detection of a failing pump component signal.

FIG. 8b shows one example of a polarization randomizer 800. In this example, polarization randomizer 800 includes a second polarization maintaining fiber 832 coupled to first polarization maintaining fiber 810 (see FIG. 8a) using an approximately forty-five degree splice 830. Forty-five degree splice 830 orients the axes of first polarization maintaining fiber 810 at approximately forty-five degrees to the axes of second polarization maintaining fiber 832. Uniformly polarized signals traversing this arrangement will result in a mixed polarized signal, tending to reduce polarization dependent gain that might otherwise occur.

In some embodiments, second polarization maintaining fiber 832 may couple to a length of non-polarization maintaining fiber. In that case, second polarization maintaining fiber 832 should comprise a length wherein orthogonally polarized components leaving second polarization maintaining fiber 832 are no longer coherent and are, therefore, effectively randomized.

FIG. 8c shows another example of a polarization randomizer 800. In this example, polarization randomizer 800 includes a polarization controller 840 coupled to polarization maintaining fiber 810. Polarization controller 840 operates to vary the polarization of incoming optical signals at a rate fast enough to reduce polarization dependent gain to an acceptable level. Optical signals are output to an optical communication link 842, which may or may not comprise a polarization maintaining fiber.

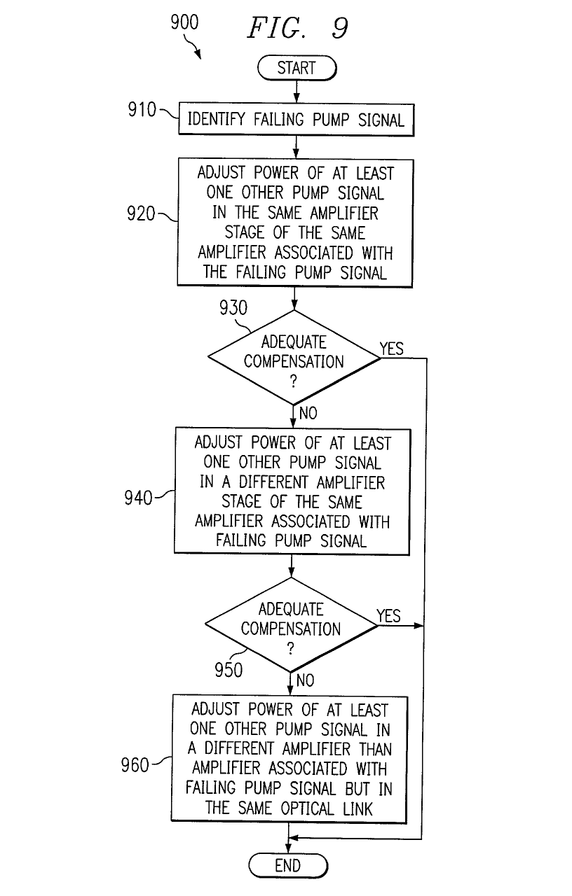

FIG. 9 is a flow chart showing one example of a method 900 of communicating optical signals. For ease of description, method 900 will be described with respect to the amplifier system depicted in FIG. 6. Method 900 could, however, apply to various amplification system designs. There is no requirement that the steps discussed below be performed in any particular order. Moreover, various of the steps discussed with respect to method 900 could be eliminated depending on the particular variation of the amplification method being implemented.

In this particular example, method 900 begins at step 910 where first amplifier 600 identifies a failing pump signal. Amplifier 600 may identify, for example, one or more pump signals 616 in first amplification stage 610 as failing pump signals. The failing pump signal could comprise a pump signal whose power has been reduced below a predetermined non-zero threshold power, or could comprise a completely failed pump signal comprising an approximately zero pump power.

In this particular example, amplifier 600 adjusts the power of at least one other pump signal 616 in the same amplifier stage 610 as the failing pump signal at step 920. Often, modifying other pump signals in the same amplifier stage within the same amplifier associated with the failing pump signal provides the simplest mechanism for compensating for the failing pump signal. In particular with respect to failing pump signals having relatively shorter wavelengths, nearly perfect or at least significant compensation can be achieved solely by modifying the powers of other pump signals in the same amplifier stage of the same amplifier as the failing pump signal. In some embodiments, adjusting the power to other pump signals in the same amplifier stage of the same amplifier as the failing pump signal can comprise the sole compensation mechanism. Alternatively, where the amplification system has additional mechanisms for compensation, the system can determine at step 930 whether adequate compensation has been achieved.

If it is determined at step 930 that additional compensation is required, one possible additional compensation mechanism is to adjust the power of at least one other pump signal in a different amplifier stage 630 of the same amplifier 600 associated with the failing pump signal at step 940. This technique can be particularly useful where, for example, one of the longer wavelength pump signals comprises the failing pump signal. Pumps 614 and 634 driving longer wavelength pump signals typically discard at least a portion of the power generated by the pumps because the longer wavelength pump signals typically comprise powers that are less than the power generated by the associated pump. As a result, pumps associated with longer wavelength pump signals typically discard at least a portion of the pump power generated. The technique described with respect to step 940 facilitates utilizing the otherwise discarded pump power to compensate for a failing pump signal in another amplifier stage.

It is generally desirable to match the wavelengths of the compensating pump signal and the failing pump signal as closely as possible, perhaps within a line width of the amplifier's gain band. Desirable results are typically obtained where the center wavelengths of the failing pump signal and the compensating pump signal are within 30 nanometers or less of one another. Although this technique can be particular advantageous when a relatively longer wavelength pump signal fails, the technique is equally applicable to failing pump signals at any wavelength.

Just as some methods may employ only the technique described with respect to step 920, other methods may employ only the step described with respect to step 940, or a combination of the steps 920 and 940.

Other embodiments may determine at step 950 that additional compensation is required. In that case, the system may adjust at step 960 the power of at least one other pump signal in a different amplifier 700 than amplifier 600 associated with the failing pump signal but in the same optical link as that amplifier.

In a particular embodiment, control/monitor functionality 622 of first stage 610 of amplifier 600 may identify failing pump signal 616, and generate a control signal 660. Amplifier 600 can communicate control signal 660, for example, in an optical service channel, to another amplifier 700 in the same optical link. In particular, amplifier 600 may communicate control signal 660 to an analogous amplification stage 710 to the amplification stage experiencing the failing pump signal. For example, if the failing pump signal occurs in first amplification stage 610 of amplifier 600, amplifier 600 may instruct first amplification stage 710 of amplifier 700 in the same optical link to adjust the power of one or more pump signals to provide inter-amplifier compensation. Favorable results are generally obtained when the compensating pump signal in amplifier 700 is chosen to have the same or a similar wavelength as the failing pump signal in amplifier 600. Choosing an analogous amplification stage in a different amplifier of the same optical link often facilitates identifying a similar or identical pump wavelength to serve as a compensating pump signal for the failing pump signal.

As with the other compensation mechanisms, the inter-amplifier compensation discussed with respect to step 960 could be used as a sole mechanism for compensating for a failing pump signal. Alternatively, inter-amplifier compensation could be used in combination with intra-stage compensation described with respect to step 920 and/or inter-stage compensation described with respect to step 940. Through use of one or a combination of these and/or other compensation techniques, various embodiments of the present invention facilitate highly reliable optical amplification without requiring 100% redundancy of driving pump signals. This facilitates effective and efficient communication of optical signals over various distances while minimizing the costs associated with optical amplifiers in the system.

Although the present invention has been described in several embodiments, a myriad of changes, variations, alterations, transformations, and modifications may be suggested to one skilled in the art, and it is intended that the present invention encompass such changes, variations, alterations, transformations, and modifications as falling within the spirit and scope of the appended claims.

What is claimed is:

1. A method of amplifying optical signals comprising:
identifying one of a plurality of pump signals driving an amplification system as a failing pump signal comprising a reduced power compared to a normal power of the failing pump signal; and
adjusting the power of at least one other of the plurality of pump signals based at least in part on the failing pump signal to at least partially compensate for a degradation of performance of the amplification system that would otherwise be caused by the reduction in power of the failing pump signal.

2. The method of claim 1, wherein identifying the failing pump signal comprises monitoring a light source generating the failing pump signal for a reduction of output power.

3. The method of claim 1, wherein identifying the failing pump signal comprises spectrally analyzing an output signal of an amplifier or amplifier stage containing the failing pump signal.

4. The method of claim 1, wherein the failing pump signal comprises a pump signal having a power below a predetermined non-zero threshold.

5. The method of claim 1, wherein the failing pump signal comprises a pump signal comprising approximately zero power.

6. The method of claim 1, wherein the failing pump signal comprises a plurality of polarization multiplexed pump signals and wherein at least one of the polarization multiplexed pump signals comprises approximately zero power.

7. The method of claim 6, wherein adjusting the power of at least one other of the plurality of pump signals comprises adjusting the power of one of the other of the plurality of polarization multiplexed pump signals comprising the failing pump signal.

8. The method of claim 6, further comprising randomizing the polarization of any remaining polarization multiplexed pump signals of the failing pump signal having a non-zero power.

9. The method of claim 1, wherein adjusting the power of at least one other of the plurality of pump signals comprises adjusting a current source driving the pump generating that pump signal.

10. The method of claim 1, further comprising adjusting a gain equalizer coupled to the amplifier to at least partially compensate for a degradation of performance of the amplification system that would otherwise be caused by the reduction in power of the failing pump signal.

11. The method of claim 1, wherein the at least one other of the plurality of pump signals comprises a pump signal generated within the same amplifier stage as the failing pump signal.

12. The method of claim 1, wherein the at least one other of the plurality of pump signals comprises a pump signal generated within another amplifier stage of the same amplifier as the failing pump signal.

13. The method of claim 12, wherein adjusting the power of the at least one other of the plurality of pump signals comprises increasing the pump power of a pump signal having a center wavelength within thirty nanometers of the center wavelength of the failing pump signal.

14. The method of claim 13, wherein a center wavelength of the at least one pump signal approximately equals a center wavelength of the failing pump signal.

15. The method of claim 1, wherein the at least one other of the plurality of pump signals comprises a pump signal generated within another amplifier serving the same optical link as the amplifier comprising the failing pump signal.

16. The method of claim 15, wherein adjusting the power of the at least one other of the plurality of pump signals comprises increasing the pump power of a pump signal having a center wavelength within thirty nanometers of a center wavelength of the failing pump signal.

17. The method of claim 16, wherein a center wavelength of the at least one pump signal approximately equals a center wavelength of the failing pump signal.

18. The method of claim 15, wherein the failing pump signal and the at least one other of the plurality of pump signals comprise pump signals serving the same amplification stage in different amplifiers serving the same optical link.

19. The method of claim 1, wherein adjusting the power of at least one other of the plurality of pump signals comprises:
adjusting the power of one or more pump signals within the same amplifier stage of the same amplifier as the failing pump signal; and
communicating to the failing amplifier stage at least a portion one or more pump signals within another amplifier stage of the same amplifier as the failing pump signal.

20. The method of claim 19, wherein the at least a portion one or more pump signals within another amplifier stage comprises a longest wavelength pump signal of that amplifier stage.

21. The method of claim 19, further comprising adjusting the power of one or more pump signals within another amplifier stage of the same amplifier as the failing pump signal.

22. The method of claim 1, wherein adjusting the power of at least one other of the plurality of pump signals comprises:
adjusting the power of one or more pump signals within the same amplifier stage as the failing pump signal; and
adjusting the power of one or more pump signals within another amplifier serving the same optical link as the amplifier comprising the failing pump signal.

23. The method of claim 1, wherein the degradation of performance comprises a loss of gain.

24. The method of claim 1, wherein the degradation of performance comprises an increase in noise figure.

25. The method of claim 1, further comprising randomizing the polarization of the failing pump signal.

26. The method of claim 1, wherein the failing pump signal resides within a discrete Raman amplifier stage.

27. The method of claim 1, wherein the failing pump signal resides within a distributed Raman amplifier stage.

28. The method of claim 1, further comprising adjusting the power of at least one redundant pump signal which was not used to drive the amplification system prior to the failure of the failing pump signal.

29. A method of amplifying optical signals comprising:
identifying any one of a plurality of active pump signals driving an amplification system as a failing pump signal comprising a reduced power compared to a normal power of the failing pump signal, each of the plurality of active pump signals generated by an active pump source; and
at least partially compensating for a degradation that would otherwise be caused by the reduction in power of the failing pump signal without requiring a redundant pump source for each of the active pump sources.

30. The method of claim 29, wherein at least partially compensating for a degradation comprises adjusting the power of at least one other of the plurality of active pump signals based at least in part on the failing pump signal.

31. The method of claim 30, wherein the at least one other of the plurality of pump signals comprises a pump signal generated within the same amplifier stage as the failing pump signal.

32. The method of claim 30, wherein the at least one other of the plurality of pump signals comprises a pump signal generated within another amplifier stage of the same amplifier as the failing pump signal.

33. The method of claim 30, wherein the at least one other of the plurality of pump signals comprises a pump signal generated within another amplifier serving the same optical link as the amplifier comprising the failing pump signal.

34. The method of claim 33, wherein adjusting the power of the at least one other of the plurality of pump signals comprises increasing the pump power of a pump signal having a center wavelength within thirty nanometers of a center wavelength of the failing pump signal.

35. The method of claim 30, wherein the failing pump signal and the at least one other of the plurality of pump signals comprise pump signals serving the same amplification stage in different amplifiers serving the same optical link.

36. The method of claim 29, wherein at least partially compensating for a degradation comprises:
adjusting the power of one or more pump signals within the same amplifier stage of the same amplifier as the failing pump signal; and
communicating to the failing amplifier stage at least a portion of one or more pump signals within another amplifier stage of the same amplifier as the failing pump signal.

37. The method of claim 36, wherein the at least a portion of one or more pump signals within another amplifier stage comprises a longest wavelength pump signal of that amplifier stage.

38. The method of claim 36, further comprising adjusting the power of one or more pump signals generated within another amplifier stage of the same amplifier as the failing pump signal.

39. The method of claim 29, wherein at least partially compensating for a degradation comprises:
adjusting the power of one or more pump signals within the same amplifier stage as the failing pump signal; and
adjusting the power of one or more pump signals within another amplifier serving the same optical link as the amplifier comprising the failing pump signal.

40. The method of claim 29, further comprising adjusting the power of at least one redundant pump signal which was not used to drive the amplification system prior to the failure of the failing pump signal.

41. A method of amplifying optical signals comprising:
identifying a failing amplifier pump signal comprising a reduced power compared to a normal power of the failing amplifier pump signal; and
in response to identifying the failing amplifier pump signal:
adjusting the power of another amplifier pump signal within the same amplifier stage of the same amplifier as the failing pump signal; and
adjusting the power of another pump signal within another amplifier stage of the same amplifier as the failing pump signal.

42. A method of amplifying optical signals comprising:
identifying a failing amplifier pump signal comprising a reduced power compared to a normal power of the failing amplifier pump signal; and
in response to identifying the failing amplifier pump signal:
adjusting the power of another amplifier pump signal within the same amplifier stage of the same amplifier as the failing pump signal; and
adjusting the power of another pump signal within another amplifier serving the same optical link as the amplifier comprising the failing pump signal.

43. The method of claim 42, wherein adjusting the power of another pump signal within another amplifier serving the same optical link comprises adjusting the power of a plurality of pump signals within one or more amplifiers serving the same optical link as the amplifier comprising the failing pump signal.

44. An optical amplification system comprising:
a pump assembly operable to generate a plurality of pump signals driving at least a portion of an amplification system;
a monitor operable to identify a failing pump signal comprising one of the plurality of pump signals having a reduced power compared to a normal power of the failing pump signal; and
a controller operable to adjust the power of at least one other of the plurality of pump signals based at least in part on the failing pump signal to at least partially compensate for a degradation of performance of the amplification system that would otherwise be caused by the reduction in power of the failing pump signal.

45. The system of claim 44, wherein the pump assembly resides in one stage of an amplifier.

46. The system of claim 44, wherein the pump assembly comprises a collection of pumps residing in separate amplifier stages of a single amplifier.

47. The system of claim 44, wherein the pump assembly comprises a collection of pumps residing in a plurality of amplifiers serving the same optical link.

48. The system of claim 44, wherein the pump assembly comprises a plurality of laser diodes.

49. The system of claim 44, wherein the monitor comprises a device operable to monitor the output of a light source generating the failing pump signal.

50. The system of claim 44, wherein the monitor comprises a spectral analyzer operable to analyze an output signal of an amplifier or amplifier stage containing the failing pump signal to identify the failing pump signal.

51. The system of claim 44, wherein the failing pump signal comprises a pump signal having a power below a predetermined non-zero threshold.

52. The system of claim 44, wherein the failing pump signal comprises a pump signal comprising approximately zero power.

53. The system of claim 44, wherein the failing pump signal comprises a plurality of polarization multiplexed pump signals and wherein at least one of the polarization multiplexed pump signals comprises approximately zero power.

54. The system of claim 53, wherein the at least one other of the plurality of pump signals comprises one of the other of the plurality of polarization multiplexed pump signals comprising the failing pump signal.

55. The system of claim 53, further comprising a polarization randomizer operable to randomize the polarization of any remaining polarization multiplexed pump signals of the failing pump signal having a non-zero power.

56. The system of claim 55, wherein the polarization randomizer comprises two polarization maintaining fibers coupled with a forty-five degree splice.

57. The system of claim 55, wherein the polarization randomizer comprises a polarization controller.

58. The system of claim 44, wherein the controller is operable to adjust a current source driving the pump generating the at least one other of the plurality of pump signals.

59. The system of claim 44, wherein the at least one other of the plurality of pump signals comprises a pump signal generated within the same amplifier stage as the failing pump signal.

60. The system of claim 44, wherein the at least one other of the plurality of pump signals comprises a pump signal generated within another amplifier stage of the same amplifier as the failing pump signal.

61. The system of claim 60, wherein a center wavelength of the at least one pump signal and a center wavelength of the failing pump signal are within thirty nanometers of one another.

62. The system of claim 61, wherein the at least one other of the plurality of pump signals comprises a pump signal having approximately the same center wavelength as the center wavelength of the failing pump signal.

63. The system of claim 44, wherein the at least one other of the plurality of pump signals comprises a pump signal generated within another amplifier residing in the same optical link as the amplifier comprising the failing pump signal.

64. The system of claim 44, wherein the degradation of performance comprises a loss of gain.

65. The system of claim 44, wherein the degradation of performance comprises an increase in noise figure.

66. The system of claim 44, wherein the failing pump signal resides within a discrete Raman amplification stage.

67. The system of claim 44, wherein the failing pump signal resides within a distributed Raman amplification stage.

68. The system of claim 44, further comprising at least one redundant pump source operable to at least partially compensate for the degradation of performance.

69. An optical amplification system comprising:
an active pump assembly operable to generate a plurality of active pump signals driving at least a portion of an amplification system;
a monitor operable to identify a failing pump signal comprising one of the plurality of active pump signals having a reduced power compared to a normal power of the failing pump signal; and
a controller operable to compensate for a degradation of performance of the amplification system that would otherwise be caused by the reduction in power of the failing pump signal without requiring a redundant pump source for each active pump source within the active pump assembly.

70. The system of claim 69, wherein the controller is operable to adjust the power of at least one other of the plurality of active pump signals based at least in part on the failing pump signal to at least partially compensate for a degradation of performance.

71. The system of claim 69, wherein the active pump assembly resides in one stage of an amplifier.

72. The system of claim 71, wherein the at least one other of the plurality of active pump signals comprises a pump signal generated within the same amplifier stage as the failing pump signal.

73. The system of claim 71, wherein the at least one other of the plurality of active pump signals comprises a pump signal generated within another amplifier stage of the same amplifier as the failing pump signal.

74. The system of claim 69, wherein the at least one other of the plurality of active pump signals comprises a pump signal generated within another amplifier residing in the same optical link as the amplifier comprising the failing pump signal.

75. The system of claim 69, further comprising at least one redundant pump source operable to at least partially compensate for the degradation of performance.

76. An optical communication system, comprising:
one or more optical transmitters operable to generate alone or collectively a plurality of signal wavelengths;
a wavelength division multiplexer (WDM) operable to combine the plurality of signal wavelengths into a single multiple wavelength signal for transmission over a transmission medium;
a pump assembly operable to generate a plurality of pump signals driving at least a portion of an amplification system coupled to the transmission medium;
a monitor operable to identify a failing pump signal comprising one of the plurality of pump signals having a reduced power compared to a normal power of the failing pump signal; and
a controller operable to adjust the power of at least one other of the plurality of pump signals based at least in part on the failing pump signal to at least partially compensate for a degradation of performance of the amplification system that would otherwise be caused by the reduction in power of the failing pump signal.

77. The system of claim 76, wherein the failing pump signal comprises a pump signal comprising approximately zero power.

78. The system of claim 76, wherein the failing pump signal comprises a plurality of polarization multiplexed pump signals and wherein at least one of the polarization multiplexed pump signals comprises approximately zero power.

79. The system of claim 78, further comprising a polarization randomizer operable to randomize the polarization of any remaining polarization multiplexed pump signals of the failing pump signal having a non-zero power.

80. The system of claim 76, wherein the controller is operable to adjust a current source driving the pump generating the at least one other of the plurality of pump signals.

81. The system of claim 76, wherein the at least one other of the plurality of pump signals comprises a pump signal generated within the same amplifier stage as the failing pump signal.

82. The system of claim 76, wherein the at least one other of the plurality of pump signals comprises a pump signal generated within another amplifier stage of the same amplifier as the failing pump signal.

83. The system of claim 76, wherein the at least one other of the plurality of pump signals comprises a pump signal generated within another amplifier residing in the same optical link as the amplifier comprising the failing pump signal.

84. The system of claim 76, wherein the degradation of performance comprises a loss of gain.

85. The system of claim 76, wherein the degradation of performance comprises an increase in noise figure.

86. The system of claim 76, wherein the failing pump signal resides within a discrete Raman amplification stage.

87. The system of claim 76, wherein the failing pump signal resides within a distributed Raman amplification stage.

88. The system of claim 76, further comprising a wavelength division demultiplexer operable to receive the multiple wavelength signal from the transmission medium and to separate the multiple wavelength signal into a plurality of individual wavelength signals.

89. The system of claim 88, further comprising a plurality of receivers each operable to convert one of the plurality of individual wavelength signals to an electrical signal.
